(19) United States
(12) Patent Application Publication
(10) Pub. No.: US 2008/0260195 A1
(43) Pub. Date: Oct. 23, 2008

(54) Flexible transmit voice tube

(75) Inventor: Steven F. Burson, Darby, MT (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., Santa Cruz, CA (US)

(21) Appl. No.: 10/788,640

(22) Filed: Feb. 27, 2004

(51) Int. Cl. H04R 19/04

(52) U.S. Cl. 381/367

(57) ABSTRACT

A hollow gooseneck or other flexible transmit voice tube for a headset for use in telecommunications, telephony, and/or multimedia applications is disclosed. The voice tube may generally include a kink-resistant flexible tubular, e.g., gooseneck, member having an open end and an opposing end for coupling to a microphone, the flexible tubular member being bendable into a curvilinear operative shape and generally retains its curvilinear operative shape throughout its operative use until further adjustment is made thereto, and a lumen defined by the flexible tubular member extending between the open and opposing ends for acoustic transmission between the open end and the microphone.

### CROSS REFERENCE TO RELATED APPLICATIONS

This application is related to co-pending U.S. patent application Ser. No. 10/______ (Attorney Docket No. 01-7118), entitled “Voice Tube Antenna for Wireless Headset” and filed concurrently herewith, which is incorporated herein by reference in its entirety.

### BACKGROUND OF THE INVENTION

1. Field of the Invention

The present invention relates generally to headsets for use in telecommunications, telephony, and/or multimedia applications. More specifically, a hollow gooseneck or other flexible transmit voice tube for a headset for use in telecommunications, telephony, and/or multimedia applications is disclosed.

2. Description of Related Art

Communication headsets are used in numerous applications and are particularly effective for telephone operators, radio operators, aircraft personnel, and for other individuals for whom it is desirable to have hands-free operation of communication systems. Accordingly, a wide variety of conventional headsets are available.

One type of communication headset is a monaural headset. Monaural headsets are headsets that have only a single audio receiver for placement near one ear. Often, such headsets are implemented with an earloop or earhook that is configured to fit around the ear to secure the receiver in place. Such headsets may be very compact.

One example of a monaural headset includes an earhook or earloop, a headset capsule and a headset boom in the form of a rigid voice or acoustic tube. The voice tube facilitates transmission of the sound or voice from a location close to a user's mouth to a microphone located at a remote location, for example inside the headset capsule. By moving the microphone from a position close to the mouth to inside the headset capsule, the headset boom can be smaller, lighter, and the rotary inertia of the headset system much smaller. These features combine to make the overall headset smaller, lighter, more stable and more comfortable, as well as more discrete.

Voice tube headsets often contain pivot joints at the juncture between the voice tube and headset capsule as well as telescoping voice tube sections that allow a far (distal) end of the voice tube to be moved to and positioned at an optimal location adjacent a user's mouth for nearly all potential users. However, the pivot joints that allow the movement and positioning of the rigid voice tubes are generally costly, heavy, and add complexity to the headset design and manufacture. If the voice tube also telescopes or trombones, then acoustic elements are provided to minimize the variability of the acoustic response of the voice tube of varying lengths, further adding to the complexity, cost and weight to the headset.

### SUMMARY OF THE INVENTION

A hollow gooseneck or other flexible transmit voice tube for a headset for use in telecommunications, telephony, and/or multimedia applications is disclosed. It should be appreciated that the present invention can be implemented in numerous ways, including as a process, an apparatus, a system, a device, or a method. Several inventive embodiments of the present invention are described below.

The voice tube may generally include a flexible tubular, e.g., gooseneck, member having an open end and an opposing end for coupling to a microphone, the flexible tubular member being bendable into a curvilinear operative shape and generally retains its curvilinear operative shape throughout its operative use until further adjustment is made thereto, and a lumen defined by the flexible tubular member extending between the open and opposing ends for acoustic transmission between the open end and the microphone.

The flexible tubular member may be a spiral wound stainless steel flexible gooseneck tubing and may be wound with copper wiring wrapped in stainless steel wire. The flexible tubular member may also include a shrink tubing over the stainless steel flexible tubing and/or a rigid collar at its open end. The curvilinear operative shape may be between a bendable limit and an unbent position, the bendable limit being a point at which further bending causes the tubular member to spring back to approximately the bendable limit, damage to the flexible tubular member, and permanent deformation of the flexible tubular member.

As another example, a headset employing a flexible voice tube such as a gooseneck voice tube may generally include a headset body coupled to an audio receiver and configured to position the audio receiver near a headset user's ear, a microphone located within the audio receiver or the headset body, and a flexible voice tube coupled to the headset body or audio receiver. The flexible voice tube defines a lumen extending between an open end to the microphone for acoustic transmission between the open end and the microphone. The flexible voice tube is preferably bendable into a curvilinear operative shape and position and preferably generally retains its curvilinear operative shape and position throughout its operative use until further adjustment is made to the flexible voice tube. The headset body may be, for example, an earloop, earhook, or a headband.

As a further example, a headset may generally include a headset body coupled to an audio receiver and configured to position the audio receiver near a headset user's ear, a microphone located within the audio receiver or headset body, and an acoustic transmission means for acoustic transmission between an open end thereof and the microphone via a lumen defined by the acoustic transmission means extending between the open end and the microphone. The acoustic transmission means is preferably adjustable into a curvilinear operative shape and preferably generally retains the curvilinear operative shape until further adjustment is made to the acoustic transmission means.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a schematic diagram of an illustrative headset with a hollow gooseneck or other flexible transmit voice tube.

FIG. 2 is a partial cross sectional view of an illustrative hollow gooseneck transmit voice tube.

FIG. 3 is a schematic diagram of an alternative headset with a hollow gooseneck or other flexible transmit voice tube.

### DESCRIPTION OF SPECIFIC EMBODIMENTS

A hollow gooseneck or other flexible transmit voice tube for a headset for use in telecommunications, telephony, and/or multimedia applications is disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

FIG. 1 is a schematic diagram of an illustrative headset 100 with a hollow gooseneck or other flexible transmit voice tube 106. In particular, the headset 100 includes a headset body such as an earloop or earhook 102, a headset or speaker (audio receiver) capsule 104, and the hollow gooseneck or other flexible transmit voice tube 106 that maintains a generally curvilinear shape, i.e., a generally smooth curved shape without kinking. The gooseneck voice tube 106 may be coupled to the headset body 102 (as shown) or to the audio receiver capsule 104.

The gooseneck voice tube 106 facilitates transmission of sound or voice from a location close to a user's mouth to a microphone (transmitter element) located at a remote location at or near a near (proximal) end 110 of the gooseneck voice tube 106, e.g., located within the headset body 102 or inside the speaker capsule 104 depending upon the specific configuration of the headset 100. By moving the microphone from a position close to the user's mouth to a remote location, the gooseneck voice tube can be smaller, lighter, more discrete, and the rotary inertia of the headset system much smaller such that the overall headset 100 is smaller, lighter, more stable and more comfortable for the user.

The hollow gooseneck transmit voice tube 106 provides various adjustability so as to allow a headset user to optimally position the far (distal) end 108 of the gooseneck voice tube 106 near the user's mouth. The hollow gooseneck transmit voice tube 106 thus eliminates a need for a telescoping voice tube as well as a pivoting joint between the gooseneck voice tube 106 and the earhook 102 (or other part of the headset 100 to which the gooseneck voice tube 106 is connected), thereby reducing the complexity of the headset 100. In addition, because the length of the hollow gooseneck transmit voice tube 106 is generally fixed, the need for acoustic elements for minimizing the variability of the acoustic response of a varying length voice tube is also eliminated, thereby further reducing the complexity, size and weight of the headset 100.

In one embodiment, a far (distal) end 108 of the gooseneck voice tube 106 may be surrounded by (or encloses) a relatively rigid or inflexible sleeve member or collar made from, e.g., from stainless steel. The inflexible sleeve member provides rigidity to the far end to facilitate sound transfer from near the user's mouth to the remote microphone.

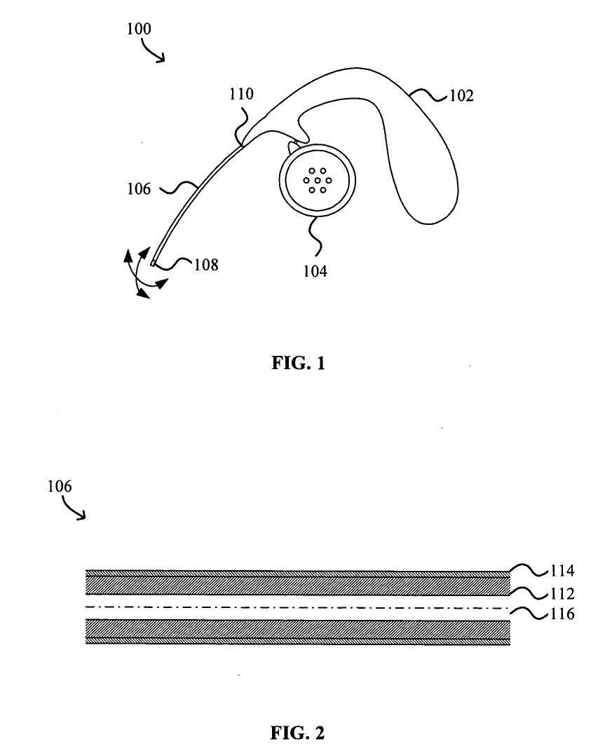

FIG. 2 is a partial cross-sectional view of an illustrative hollow gooseneck transmit voice tube 106. The construction of the gooseneck voice tube 106 is preferably such that the gooseneck voice tube 106 is generally flexible and adjustable over its entire length and that, once adjusted and/or positioned, the gooseneck voice tube 106 retains its general shape and position throughout its operative use until further adjusted or positioned. The gooseneck voice tube 106 is preferably selectively flexible and/or bendable in any desired direction and into any desired position within its bendable limit. In other words, the bendable limit of the gooseneck voice tube 106 determines the range of motion for the gooseneck voice tube 106. Generally, the bendable limit is the point at which further bending of the gooseneck voice tube 106 causes the gooseneck voice tube 106 to return to its bendable limit (e.g., springs back) and/or causes damages and/or permanently deforms the gooseneck voice tube 106, for example. The bendable limit of the gooseneck voice tube 106 depends on, for example, the materials used and the dimensions of the gooseneck voice tube 106. The gooseneck voice tube 106 is typically bendable to any desired curvilinear operative position between the straight or unflexed position and the bendable limit and preferably retains its general shape and position throughout its operative use until further adjusted or positioned. It is noted that when bending or shaping the voice tube 106 to within its bendable limit, the gooseneck voice tube 106 generally retains its shape but may experience some spring back upon initial release of pressure applied on the gooseneck voice tube 106.

As shown, the gooseneck voice tube 106 includes a tubular member 112, i.e., hollow and defining a lumen, passageway, or bore 116 therethrough. The lumen 116 facilitates transmission of sound or voice from a location close to a user's mouth to the remote microphone. The voice tube 106 is preferably kink resistant such that the lumen 116 generally retains its cross sectional shape and size even when the voice tube 106 is bent to a desired shape.

The voice tube 106 may be a flexible tube with a metallic stiffening member such that the voice tube 106 may be deformed and retain the desired shape and/or position of the voice tube. As an example, the tubular member 112 may be formed of metal and/or plastic, e.g., molded plastic with individual sections that snap together. As another example, the tubular member 112 may be formed from spiral wound stainless steel flexible tubing. In particular, the tubular member 112 may be formed from stainless steel wire, e.g., 302-304 stainless steel, and copper wire wrapped between the stainless steel wire 112. The copper wire may be secured at each end by soldering. The gooseneck voice tube 106 may be formed from any suitable material in a variety of configurations such as a metal and/or flexible plastic pipe or conduit or other flexible tube. In the case of a flexible plastic pipe, the plastic pipe be stiffened with a metallic stiffening member, for example. The gooseneck voice tube 106 may further include a shrink tubing 114 over the stainless steel. The shrink tubing 114 may be a polymeric skin or film that facilitates in cleaning of the gooseneck voice tube 106 and may improve the overall aesthetics of the headset 100.

The specific parameters for the hollow gooseneck transmit voice tube 106, e.g., length, diameter, stiffness and look of the tube, may be optimized for specific headset designs and/or frequency responses, for example. Merely as example, the stainless steel tubular member 112 may have an outer diameter of approximately 0.096″ and an inner diameter of approximately 0.040″, i.e., the diameter of the lumen 116 defined by the stainless steel tubular member. The shrink tubing 114 may have a thickness of approximately 0.009″ such that the total diameter of the gooseneck voice tube 106 may be approximately 0.114″. The length of the gooseneck voice tube 106 may be, for example, approximately 4 inches.

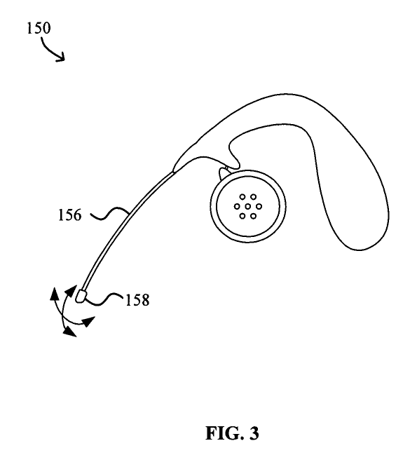

FIG. 3 is a schematic diagram of an alternative headset 150 with a hollow gooseneck or other flexible transmit voice tube 156. As shown, the far end of the gooseneck voice tube 156 is surrounded by (or surrounds) a larger and relatively inflexible sleeve member or collar 158 formed of, e.g., stainless steel. The larger collar 158 may facilitate the user in providing a better grip at the far end of the voice tube 156 for positioning and adjusting of the gooseneck voice tube 156, such as by bending and/or otherwise positioning, the gooseneck voice tube 156.

The hollow gooseneck transmit voice tube as described herein may help to lower the headset cost as the gooseneck voice tube eliminates the need for a pivoting joint and/or acoustic elements as noted above. In addition, the gooseneck voice tube also helps to free up various constraints on the interface between the voice tube and the earhook (or speaker capsule) to allow more flexibility to industrial design.

It is noted that while the hollow gooseneck transmit voice tube is shown and described herein as implemented in a monaural communications headset with an earloop or earhook as the headset body, the gooseneck voice tube may be implemented in any suitable communications headset such as a binaural headset or a monaural headset. The headset may be alternatively implemented with a headband rather than a earloop or earhook as the headset body, where the headband extends fully or partially around the user's head. In addition, the headset may be wired or wireless.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A headset, comprising:
an audio receiver;
a headset body to which the audio receiver is coupled, the headset body being configured to position the audio receiver near a headset user's ear;
a microphone located within one of the audio receiver and the headset body; and
a flexible voice tube coupled to one of the headset body and the audio receiver, the flexible voice tube defining a lumen therein extending between an open end of the flexible voice tube to the microphone for acoustic transmission between the open end of the voice tube and the microphone, the flexible voice tube being bendable into a curvilinear operative shape and position while preventing kinking of the flexible voice tube, the flexible voice tube generally retaining its curvilinear operative shape and position throughout its operative use until further adjustment.

2. The headset of claim 1, wherein the flexible voice tube is a spiral wound stainless steel flexible gooseneck tubing.

3. The headset of claim 1, wherein the flexible voice tube is a spiral wound flexible gooseneck tubing, the gooseneck voice tube including copper wiring wrapped in stainless steel wire.

4. The headset of claim 1, wherein the flexible voice tube includes a shrink tubing over a stainless steel flexible tubing.

5. The headset of claim 1, wherein the flexible voice tube includes a rigid collar at the open end thereof.

6. The headset of claim 1, wherein the headset body is selected from the group consisting of an earloop, earhook, and a headband.

7. The headset of claim 1, wherein the curvilinear operative shape and position is between a bendable limit and an unbent position, the bendable limit of the flexible voice tube being a point at which further bending of the flexible voice tube causes at least one of spring back to approximately the bendable limit, damage to the flexible voice tube, and permanent deformation of the flexible voice tube.

8. A voice tube, comprising:
a kink-resistant flexible tubular member having an open end and an opposing end, the opposing end being configured to be coupled to a microphone, the flexible tubular member being configured to be bendable into a curvilinear operative shape and preventing formation of kinks in the flexible tubular member, the flexible tubular member being configured to generally retain its curvilinear operative shape throughout its operative use until further adjustment is made thereto; and
a lumen defined by the flexible tubular member extending between the open end and the opposing end for acoustic transmission between the open end and the microphone.

9. The voice tube of claim 8, wherein the flexible tubular member is a gooseneck member.

10. The voice tube of claim 8, wherein the flexible tubular member is a spiral wound stainless steel flexible gooseneck tubing.

11. The voice tube of claim 8, wherein the flexible tubular member is a spiral wound flexible gooseneck tubing, the gooseneck voice tube including copper wiring wrapped in stainless steel wire.

12. The voice tube of claim 8, wherein the flexible tubular member includes a shrink tubing over a stainless steel flexible tubing.

13. The voice tube of claim 8, wherein the flexible tubular member includes a rigid collar at the open end thereof.

14. The voice tube of claim 8, wherein the curvilinear operative shape is between a bendable limit and an unbent position, the bendable limit of the flexible tubular member being a point at which further bending of the flexible tubular member causes at least one of spring back to approximately the bendable limit, damage to the flexible tubular member, and permanent deformation of the flexible tubular member.

15. A headset, comprising:
an audio receiver;
a headset body to which the audio receiver is coupled, the headset body being configured to position the audio receiver near a headset user's ear;
a microphone located within one of the audio receiver and the headset body; and
acoustic transmission means for acoustic transmission between an open end thereof and the microphone via a lumen defined by said acoustic transmission means extending between the open end and the microphone, said acoustic transmission means being kink resistant and adjustable into a curvilinear operative shape and generally retaining the curvilinear operative shape until further adjustment is made thereto.

16. The headset of claim 15, wherein the flexible voice tube is a spiral wound stainless steel flexible gooseneck tubing.

17. The headset of claim 15, wherein the acoustic transmission means is selected from the group consisting of:
a spiral wound flexible gooseneck tubing, the gooseneck voice tube including copper wiring wrapped in stainless steel wire; and
a shrink tubing over a stainless steel flexible tubing.

18. The headset of claim 15, wherein the acoustic transmission means includes a rigid collar at the open end thereof.

19. The headset of claim 15, wherein the headset body is selected from an earloop, earhook, and a headband.

20. The headset of claim 15, wherein the curvilinear operative shape is between a bendable limit and an unbent position, the bendable limit of the acoustic transmission means being a point at which further bending of the acoustic transmission means causes at least one of spring back to approximately the bendable limit, damage to the acoustic transmission means, and permanent deformation of the acoustic transmission means.
